(19) United States
(12) Patent Application Publication
(10) Pub. No.: US 2002/0159003 A1
(43) Pub. Date: Oct. 31, 2002

(54) Transmission type display device

(76) Inventors: Takashi Sato, Tenri-shi (JP); Noriko Watanabe, Nara-shi (JP); Shigeaki Mizushima, Ikoma-shi (JP)

Correspondence Address: NIXON & VANDERHYE P.C., 8th Floor, 1100 North Glebe Rd., Arlington, VA, 22201-4714, US

(21) Appl. No.: 10/082,259

(22) Filed: Feb. 26, 2002

(30) Foreign Application Priority Data
Feb. 27, 2001 (JP) 2001-051398

(51) Int. Cl. G02F 1/1335

(52) U.S. Cl. 349/65

(57) ABSTRACT

A transmission type display device includes: a backlight source; a display element, which is disposed in front of the backlight source and includes at least one polarizer; a light diffusing element, which is disposed in front of the display element; and a polarizing element, which is disposed in front of the light diffusing element. In this display device, the polarizer included in the display element faces the light diffusing element, and an absorption axis of the polarizing element is substantially aligned with that of the polarizer.

### BACKGROUND OF THE INVENTION

1. Field of the Invention

The present invention relates to a direct view type liquid crystal display device for use in office automation (OA) appliances including word processors and notebook computers, various types of video or game appliances, TV receivers and other electronic appliances.

2. Description of the Related Art

A cathode ray tube (CRT) has been used widely as a display for personal computers, word processors, TV receivers and so on. Recently, however, as there is a growing demand for reduction in the size, thickness and weight of these electronic appliances, a flat panel display is adopted more and more often as an alternative display. Several types of flat panel displays are now available. A liquid crystal display device, among other things, is used particularly extensively because a liquid crystal display device has a number of advantages including low power dissipation.

A liquid crystal display device utilizes the electro-optical effects of liquid crystal molecules to conduct a display operation. More specifically, by taking advantage of the optical anisotropy (i.e., refractive index anisotropy), orientation characteristic, fluidity or dielectric anisotropy of liquid crystal molecules, a liquid crystal display device changes its light transmittance or reflectance by applying an electric field, or supplying a current, to an arbitrary selected display area unit of the display device. Liquid crystal display devices are roughly classifiable into: direct view types that allow the viewer to directly observe an image presented on the display device; and projection types that allow him or her to observe an image that has been projected onto a screen from the display device disposed in front of or behind the viewer.

A direct view type liquid crystal display device may operate in dynamic scattering mode, twisted nematic mode, super twisted nematic mode, polymer dispersed mode, ferroelectric liquid crystal mode, homeotropic mode or guest host mode. Also, a liquid crystal display device of the direct view type may be driven by segment addressing, simple matrix addressing or active matrix addressing. These display modes and driving schemes may be combined in various manners. For example, if the display device includes a relatively small number of display area units (i.e., pixels), then the device is normally driven by the segment addressing and operated in the twisted nematic mode. On the other hand, if the display device includes a relatively large number of pixels, then the device is often driven by the simple matrix addressing and operated in the super twisted nematic mode.

A liquid crystal display device is used to display various types of information including characters, graphics and so on. However, as the size of information to be displayed on a liquid crystal display device is escalating these days, the display device is often operated in a so-called “dot-matrix mode”, in which desired information is presented by using pixels of a very small size that are arranged in columns and rows.

A direct view type liquid crystal display device includes a liquid crystal display cell having an optical shuttering function as its core element. If necessary, a backlight source for illuminating the display screen from behind the screen and/or an antireflective film for minimizing the unwanted reflection of external light from the viewing plane are/is combined with the cell.

Various techniques have been proposed to minimize the variation in display quality of a liquid crystal display device depending on the viewing direction and thereby expand a viewing angle range in which good display quality is ensured. Those techniques are roughly classifiable into methods of modifying the internal configuration of its liquid crystal display cell and methods of modifying the external configuration of the liquid crystal display cell. Examples of the former internal modifications include modifying the properties of liquid crystal molecules, optimizing the arrangement of polarizers or the orientations of liquid crystal molecules, providing multiple birefringence films inside the liquid crystal display device, finely roughening the surface of the substrates, and appropriately changing the driving schemes. As an external modification of the latter type, the liquid crystal display cell may be combined with a lens or some optical element for controlling the light transmitting direction.

The viewing angle range may be expanded by disposing a light diffusing layer (e.g., lens) for controlling the light transmitting direction on the observer side of a liquid crystal display cell. For example, a micro lens array sheet, on which micro-lenses are arranged so as to form a single plane and are colored by coloring agents, may be used as disclosed in Japanese Laid-Open Publication No. 7-64071. Also, in a lens array sheet, some of the lenses may be partially covered with an opaque layer as disclosed in Japanese Laid-Open Publication No. 6-27454. Furthermore, where a liquid crystal display cell is secured to the convex portions of lenses via an adhesive or pressure sensitive adhesive layer, the unwanted reflection of external light from those lenses may be reduced by making the lens height, lens pitch and adhesive layer width satisfy a predetermined relationship (see U.S. Pat. No. 5,555,476). Moreover, a light diffusing layer may be provided between a color filter substrate, which is disposed on the observer side of a liquid crystal display panel, and a polarizing element, which is disposed in front of the color filter substrate, as disclosed in Japanese Laid-Open Publication No. 10-10513.

According to the techniques disclosed in Japanese Laid-Open Publication Nos. 7-64071 and 6-27454, the display quality is improvable because the viewing angle range of the liquid crystal display device can be expanded and the retroreflection of externally incoming light, which has been incident on the device from behind the observer, from the lenses on the observer side can be reduced. This is because the externally incoming light is absorbed into the opaque layer. However, this opaque layer also absorbs the light that has been emitted from the backlight source of the liquid crystal display device. Thus, to obtain sufficiently high display brightness, the output power of the backlight source must be increased according to those techniques.

It is true that the technique described in U.S. Pat. No. 5,555,476 contributes to reducing the quantity of the unwanted light reflected from the observer side. But if the quantity of the light is reduced excessively, then it does not make so much sense even when the viewing angle range is expanded by using the lenses. In the technique disclosed in Japanese Laid-Open Publication No. 10-10513, the light diffusing layer is provided between the color filter substrate and the polarizer to reduce the undesired reflection of the external light by getting the light absorbed into the polarizer and thereby minimize the decrease in brightness of the image displayed on the liquid crystal display panel. However, where the light diffusing layer is interposed between the polarizer and the color filter substrate, depolarization occurs unintentionally, thus deteriorating the viewing angle characteristic disadvantageously.

### SUMMARY OF THE INVENTION

In order to overcome the problems described above, the present invention provides a transmission type display device that can display a bright image thereon while minimizing the whitening of the image on the screen due to the excessive retroreflection of externally incoming light.

A transmission type display device according to the present invention includes backlight source, display element with at least one polarizer, light diffusing element and polarizing element. The display element is disposed in front of the backlight source. The light diffusing element is disposed in front of the display element. The polarizing element is disposed in front of the light diffusing element. The polarizer included in the display element faces the light diffusing element. An absorption axis of the polarizing element is substantially aligned with that of the polarizer.

In one preferred embodiment of the present invention, the display element includes transmission type liquid crystal display panel and first and second polarizers. The transmission type liquid crystal display panel includes a liquid crystal layer and a pair of transparent substrates that sandwiches the liquid crystal layer therebetween. The first polarizer is disposed as an additional polarizer on the transmission type liquid crystal display panel so as to face the backlight source. The second polarizer is disposed as the at least one polarizer on the transmission type liquid crystal display panel so as to face the light diffusing element. An absorption axis of the second polarizer is substantially aligned with that of the polarizing element.

In this particular preferred embodiment, the display device may further include: a first λ/4 retarder disposed between the second polarizer and the light diffusing element; and a second λ/4 retarder disposed between the light diffusing element and the polarizing element. In that case, a slower axis of the first λ/4 retarder preferably forms an angle of about 45 degrees with an absorption axis or transmission axis of the second polarizer. A slower axis of the second λ/4 retarder preferably forms an angle of about 90 degrees with that of the first λ/4 retarder.

In another preferred embodiment, at least one of the first and second polarizers may be integrated with an associated one of the transparent substrates.

In still another preferred embodiment, the display element may include: a guest host type liquid crystal display panel; and the at least one polarizer disposed in front of a light outgoing plane of the guest host type liquid crystal display panel.

In this particular preferred embodiment, the polarizer may be integrated with a transparent substrate, which is located closer to the light outgoing plane, in the guest host type liquid crystal display panel.

Another transmission type display device according to the present invention includes backlight source, display element, light diffusing element, and polarizing element. The display element is disposed in front of the backlight source and outputs polarized light. The light diffusing element is disposed in front of the display element. The polarizing element is disposed in front of the light diffusing element. In this display device, an absorption axis of the polarizing element is defined so that substantially all of the polarized light that has been output from the display element is transmitted through the polarizing element.

Still another transmission type display device according to the present invention includes backlight source, guest host type liquid crystal display element and polarizing element. The backlight source emits polarized light. The guest host type liquid crystal display element is disposed in front of the backlight source. The polarizing element is disposed in front of the guest host type liquid crystal display element. In this display device, an absorption axis of the polarizing element is defined so that substantially all of the polarized light is transmitted through the polarizing element.

The present invention also provides an electronic apparatus including the above-mentioned transmission type display device that can display a bright image thereon while minimizing the whitening of the image on the screen due to the excessive retroreflection of externally incoming light.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view illustrating a configuration for a liquid crystal display device according to a first specific preferred embodiment of the present invention.

FIG. 2A is a cross-sectional view illustrating a configuration for a liquid crystal display device according to a second specific preferred embodiment of the present invention; and

FIG. 2B illustrates an axial relationship between the absorption or transmission axes of the polarizing element and polarizer and the slower axes of the λ/4 retarders for the device shown in FIG. 2A.

FIG. 3 is a cross-sectional view schematically illustrating a main part of a conventional liquid crystal display device.

FIG. 4 is a cross-sectional view schematically illustrating a main part of the liquid crystal display device of the first preferred embodiment.

FIG. 5 is a cross-sectional view schematically illustrating a main part of the liquid crystal display device of the second preferred embodiment.

FIG. 6 illustrates an axial relationship between the absorption or transmission axes of the polarizing element and polarizer and the slower axes of the λ/4 retarders for the device shown in FIG. 5.

### DETAILED DESCRIPTION OF PREFERRED EMBODIMENTS

Hereinafter, preferred embodiments of the present invention will be described with reference to the accompanying drawings and by comparison with the prior art.

Embodiment 1

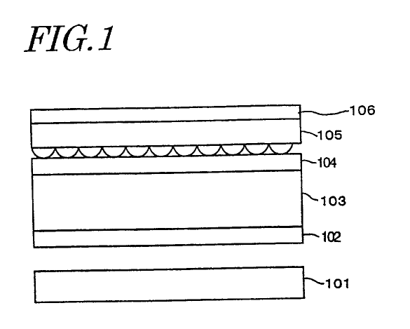

FIG. 1 illustrates a configuration for a transmission type liquid crystal display device according to a first specific preferred embodiment of the present invention.

In this preferred embodiment, a first polarizer 102 is disposed between a backlight source 101 and a liquid crystal display panel 103, and a second polarizer 104 is disposed on the opposite side of the liquid crystal display panel 103 as shown in FIG. 1. That is to say, the first polarizer 102 faces the backlight source 101 but the second polarizer 104 does not. A light diffusing element 105 is provided in front of the second polarizer 104. As used herein, when a first member is located “in front of” a second member, the first member is closer to the observer than the second member is. And a polarizing element (third polarizer) 106 is further provided in front of the light diffusing element 105. The polarizing element 106 is disposed so that the absorption axis of the polarizing element 106 is aligned with that of the second polarizer 104.

Without the polarizing element 106, the light diffusing element 105 would retro-reflect the light that has been incident on the front of the liquid crystal display device (i.e., externally incoming light) to its original direction, thereby whitening the image displayed on the screen and degrading the resultant display quality. However, if the polarizing element 106 is disposed in front of the light diffusing fusing element 105 as shown in FIG. 1, the light that has been retro-reflected from the light diffusing element 105 can be absorbed into the polarizing element 106 and the degradation in display quality is minimizable. In addition, the absorption axis of the polarizing element 106 is aligned with that of the second polarizer 104 disposed on the front of the liquid crystal display panel 103. Thus, almost all of the polarized light, which has gone out of liquid crystal display panel 103, is transmitted through the polarizing element 106. As a result, the brightness of an image displayed on the liquid crystal display device does not decrease.

Hereinafter, the display device of this preferred embodiment will be further detailed in comparison with a conventional transmission type liquid crystal display device.

First, a typical configuration for a conventional transmission type liquid crystal display device will be described with reference to FIG. 3. The conventional transmission type liquid crystal display device includes: a backlight source 1; a liquid crystal display element 2 disposed in front of the backlight source 1; and a light diffusing layer 3 disposed in front of the liquid crystal display element 2. The backlight source 1 includes: a light guiding member 1b for evenly outputting a light ray, which has been emitted from a cold cathode fluorescent lamp 1a, onto a plane; a diffusion reflective sheet 1c for reflecting the light, which has been emitted toward behind the light guiding member 1b, back to the observer side; and a louver sheet 1d for converging the outgoing light. The liquid crystal display element 2 includes an active matrix substrate 21 and a color filter substrate 22. In the active matrix substrate 21, thin-film transistors (TFTs) 2b are formed in matrix on a transparent glass substrate 2a, and transparent electrodes 2c and an alignment film 2d are deposited in this order over the TFTs 2b on the glass substrate 2a. In the color filter substrate 22 on the other hand, a color filter layer 2f, a transparent electrode 2e and an alignment film 2g are formed in this order on another transparent glass substrate 2a. A liquid crystal layer 2h made of a twisted nematic (TN) liquid crystal material with a twist angle of approximately 90 degrees is sealed in between these substrates 21 and 22. The liquid crystal layer 2h is made of a liquid crystal material having positive dielectric anisotropy. These substrates 21 and 22 are sandwiched between a pair of polarizers 2i and 2j. The polarizers 2i and 2j are disposed so that the absorption or transmission axes thereof form an angle of approximately 90 degrees between them.

In the example illustrated in FIG. 3, the light diffusing layer 3 is implemented as a lenticular lens that exhibits lens effects only in one direction. This lenticular lens is made up of lens support 3a, lens portion 3b and light absorbing layer 3c for minimizing the retroreflection. The lenticular lens 3 is secured via an adhesive layer 4 to the surface of the polarizer 2j that is disposed closer to the observer, and diffuses the light that has gone out of the liquid crystal display element 2. The liquid crystal display element 2 had a screen size of about 15 inches diagonally (about 228.6 mm vertically and about 304.8 mm horizontally). Pixels were arranged to form a striped pattern, in which the number of horizontal R, G and B pixels was 640 and the number of vertical pixels was 480. And the pixels were arranged at a horizontal pitch of about 0.159 mm and at a vertical pitch of about 0.476 mm.

Although not shown in FIG. 3, a modulation controller is connected to the transparent electrodes to change the orientation states of the liquid crystal molecules. By creating an electric field as an external field on the application of a display voltage, the controller controls the orientations of the liquid crystal molecules and thereby modulates the light intensity.

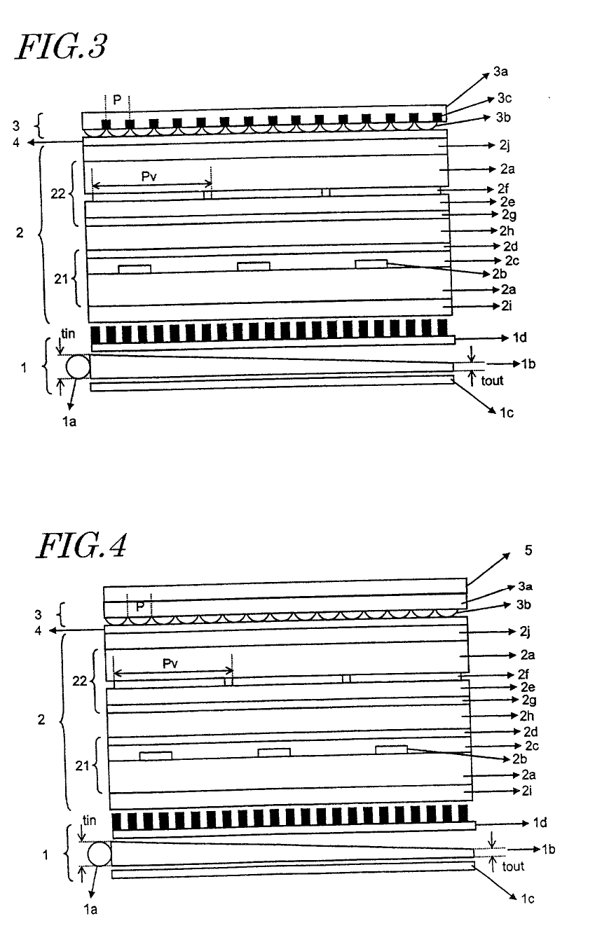

FIG. 4 illustrates a configuration for a display device according to the first specific preferred embodiment of the present invention. In FIG. 4, each component having substantially the same function as the counterpart shown in FIG. 3 is identified by the same reference numeral. Comparing the display devices shown in FIGS. 3 and 4 with each other, it can be easily seen that the device shown in FIG. 4 includes no light absorbing layer 3c for absorbing the retro-reflected light in the lenticular lens 3 but instead further includes an additional polarizing element (or third polarizer) 5 in front of the light diffusing layer 3. As described above, this polarizing element 5 is disposed so that the absorption axis thereof is aligned with that of the second polarizer 2j. In this configuration, the quantity of external light incoming through the front of the light diffusing layer 3 can be reduced and the retro-reflected light can be absorbed into the polarizing element 5 even though no light absorbing layer 3c is provided for the light diffusing layer 3. Accordingly, degradation in display quality, such as whitening of an image displayed on the screen, is suppressible. In addition, since the absorption axis of the polarizing element 5 is aligned with that of the second polarizer 2j, decrease in brightness is also minimizable.

Hereinafter, it will be described how to fabricate the liquid crystal display device shown in FIG. 4.

The transparent glass substrates 2a were made of 7059 glass (produced by Corning Glass Works) with a thickness of about 0.5 mm. The transparent electrodes 2c and 2e were formed over the glass substrates 2a out of an ITO film by a sputtering process. Next, alignment films 2d and 2g of polyimide were formed thereon by a printing method, baked at about 180° C. and then subjected to a rubbing treatment. The alignment films 2d and 2g formed in this manner had a twist angle of about 90 degrees. Thereafter, to keep the thickness of the liquid crystal layer 2h constant, glass fiber spacers with a particle size of about 4.5 μm were dispersed. Then, an adhesive seal member, containing glass fiber spacers with a particle size of about 5.3 μm, was screen-printed as a liquid crystal sealing layer, thereby bonding the two substrates 21 and 22 together. Next, the gap between the two substrates 21 and 22 was evacuated and then a liquid crystal material was injected into the gap to obtain a TN liquid crystal cell. Thereafter, the polarizers 2i and 2j were formed thereon so that their absorption axes formed an angle of approximately 90 degrees between them. In this preferred embodiment, each of these polarizers 2i and 2j was formed to have a thickness of about 0.25 mm by adding a dye to uniaxially extended polyvinyl alcohol and then getting the material sandwiched between a pair of protective films of triacetyl cellulose. Subsequently, the surface of the polarizer 2j is coated with an acrylic UV-curable adhesive. Next, the light diffusing layer 3 is bonded onto the polarizer 2j via the adhesive and then the UV-curable adhesive is exposed to, and cured by, a UV ray.

The light diffusing layer 3 was formed by dripping a UV-curable resin Z9001 (produced by JSR Corp. and with a refractive index n of 1.59) onto a die in which an array of concave portions had been formed, exposing the resin to a UV ray with an intensity of 1.0 J/cm² to cure it and transferring the resultant convex portions onto a base material. In this process step, an Arton film produced by JSR Corp. was used as the lens support 3a. The lenses may also be formed by any other technique. For example, the lenses may be formed by thermally deforming a resist film on a transparent substrate, by subjecting an acrylic resin to an injection molding process, or by subjecting a glass substrate to an ion exchange or an etching process. The lenticular lens was formed as a series of lenses that were arranged in parallel to the horizontal pixels included in the liquid crystal display element 2. The lenses had a pitch P of about 0.06 mm, a height of about 0.017 mm and a focal length of about 0.25 mm. The polarizing element 5 with a thickness of about 0.25 mm was disposed in front of the light diffusing layer 3 so that the absorption axis of the polarizing element 5 was aligned with that of the polarizer 2j. The polarizing element 5 was made of the same material as that of the polarizers 2i and 2j.

Like the device shown in FIG. 3, the backlight source 1 is made up of the cold cathode fluorescent lamp 1a, light guiding member 1b, diffusion reflective sheet 1c and louver sheet 1d. The light guiding member 1b was formed in the shape of a wedge. One side of the wedge, through which the incoming light was passed, had a thickness tᵢₙ of about 4 mm, while the opposite side of the wedge had a thickness tₒᵤₜ of about 2 mm. A surface of the light guiding member 1b on the opposite side of its emission surface was finely crinkled by a crepe printing process, and the diffusion reflective sheet 1c was disposed on the surface. On the emission surface of the light guiding member 1b, a louver sheet produced by Sumitomo 3M, Ltd. was placed as the louver sheet 1d.

The liquid crystal display devices, having the conventional configuration shown in FIG. 3 and the configuration of this preferred embodiment shown in FIG. 4, respectively, had their display characteristics evaluated in respects of front brightness and degree of whitening caused by the retroreflection of externally incoming light. As used herein, the “front brightness” refers to the brightness of an image displayed as measured along a normal that crosses the display screen at right angles. The results are shown in the following Table 1:

TABLE 1

| | | Whitening due to |
|---|---|---|
| | Front brightness | Retroreflection |
| Conventional | 300 nt | Good |
| Embodiment 1 | 380 nt | Good |
| Embodiment 2 | 380 nt | Good |

As can be seen from the results shown in Table 1, the liquid crystal display device of this preferred embodiment ensures good display quality while minimizing the decrease in brightness.

In the preferred embodiment described above, a liquid crystal display element including a TN liquid crystal cell with a twist angle of approximately 90 degrees is used. However, any other type of liquid crystal display element may also be used to achieve the same effects as those described for this preferred embodiment so long as the device outputs polarized light. For example, a guest host type liquid crystal cell may be disposed in front of the backlight source 1 and the polarizer 2j may be disposed in front of the liquid crystal cell to make up the liquid crystal display element 2. Alternatively, a backlight source for emitting polarized light may also be used and a guest host type liquid crystal cell may also be disposed in front of the backlight source to make up the liquid crystal display element 2.

Embodiment 2

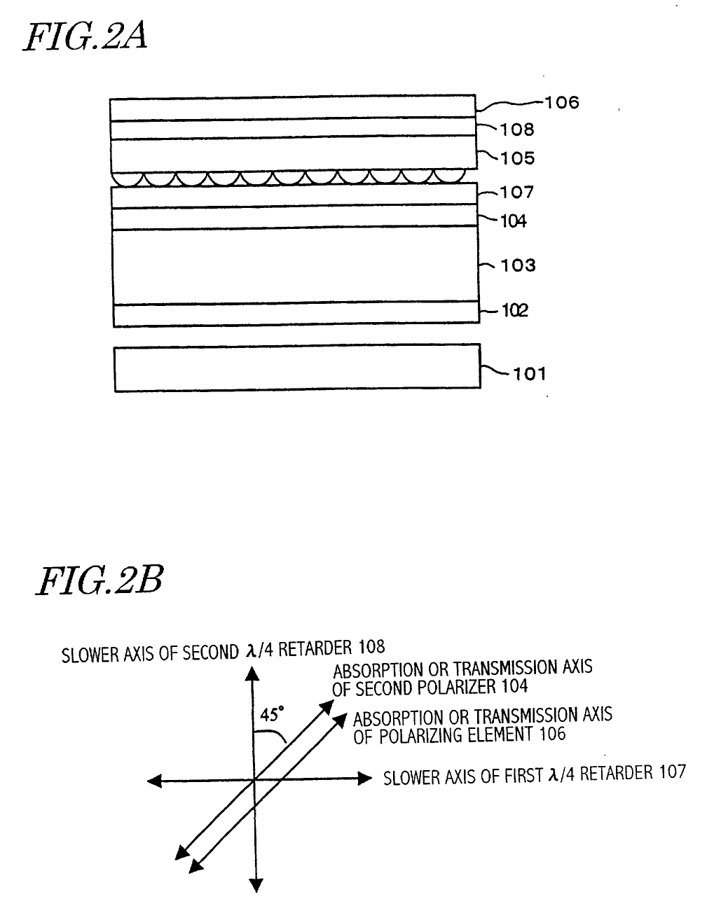

Hereinafter, a display device according to a second specific preferred embodiment of the present invention will be described with reference to FIGS. 2A and 2B.

FIG. 2A illustrates a schematic configuration for the display device of this preferred embodiment, while FIG. 2B illustrates the directions of the optical axes of respective optical elements included in the device shown in FIG. 2A. Comparing the devices of the first and second preferred embodiments shown in FIGS. 1 and 2A with each other, it can be easily seen that the device shown in FIG. 2A further includes a first λ/4 retarder 107 between the second polarizer 104 and the light diffusing element 105 and a second λ/4 retarder 108 between the polarizing element 106 and the light diffusing element 105, respectively. In the other respects, the device of this second preferred embodiment is the same as the counterpart of the first embodiment, and the description thereof will be omitted herein.

The first and second λ/4 retarders 107 and 108 are disposed so that the slower axes thereof and the absorption or transmission axes of the second polarizer 104 and polarizing element 106 satisfy the axial relationship shown in FIG. 2B. Suppose the slower axis of the second λ/4 retarder 108 and the absorption or transmission axis of the polarizing element 106 form an angle of about 45 degrees as shown in FIG. 2B. In that case, the incoming light, which has been incident onto the front of the liquid crystal display device, is turned by the polarizing element 106 into linearly polarized light, which is then turned into circularly polarized light by the second λ/4 retarder 108. Part of this circularly polarized light is reflected from the light diffusing element 105 without changing its plane of polarization and then transmitted through the second λ/4 retarder 108 again so as to be turned into linearly polarized light with a polarization axis that has been rotated by about 90 degrees. Accordingly, the linearly polarized light is absorbed into the polarizing element 106, thus further reducing the retroreflection of the externally incoming light. However, if just the second λ/4 retarder 108 was provided, the light that has gone out of the light diffusing element 105 would also be turned into circularly polarized light and approximately half of the light would be absorbed into the polarizing element 106. As a result, an image displayed on the liquid crystal display device would have a decreased brightness. To avoid this unwanted situation, the first λ/4 retarder 107 is provided in this preferred embodiment between the second polarizer 104 and the light diffusing element 105 so that the slower axis of the first λ/4 retarder 107 forms an angle of approximately 90 degrees with that of the second λ/4 retarder 108. Then, the linearly polarized light, which has been transmitted through the second polarizer 104, passes through the polarizing element 106 without changing its plane of polarization. Consequently, the brightness of the image displayed on the liquid crystal display device does not decrease and the retroreflection caused by the light diffusing element 105 can be reduced.

FIG. 5 illustrates an exemplary specific configuration for the liquid crystal display device of this preferred embodiment. In FIG. 5, each component having substantially the same function as the counterpart shown in FIGS. 3 or 4 is identified by the same reference numeral, and the description thereof will be omitted herein. In addition to all the components of the liquid crystal display device of the first preferred embodiment shown in FIG. 4, the device of this second preferred embodiment shown in FIG. 5 further includes a first λ/4 retarder 6 between the second polarizer 2j and the light diffusing layer 3 and a second λ/4 retarder 7 between the light diffusing layer 3 and the polarizing element 5, respectively.

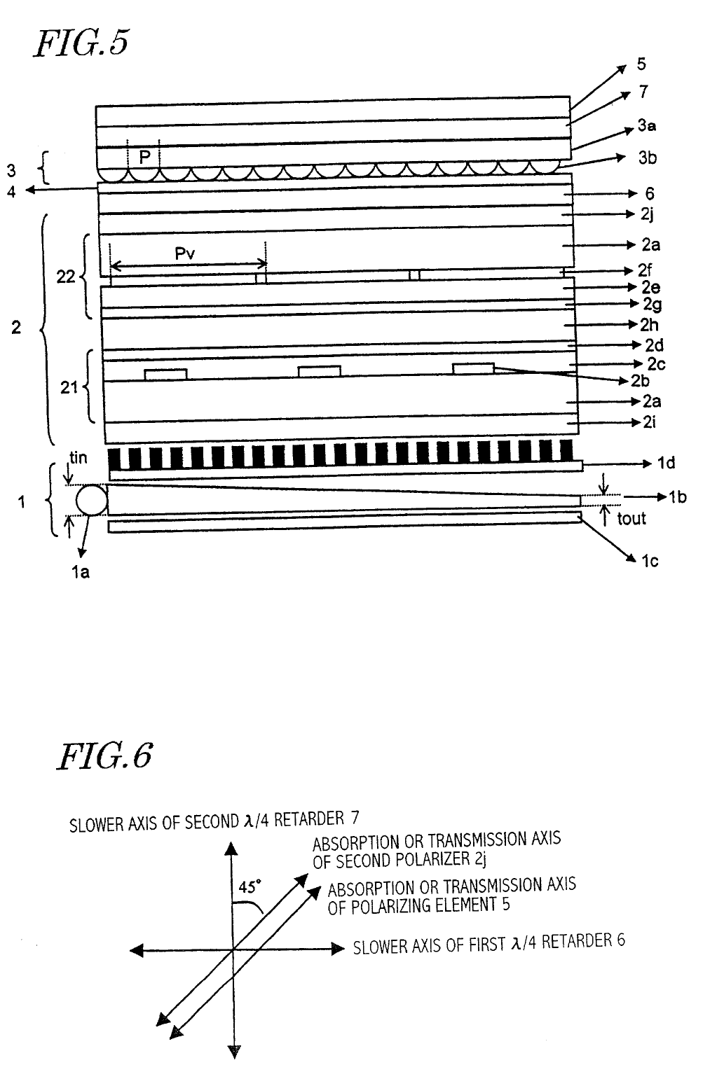

The first and second λ/4 retarders 6 and 7 are disposed so that the slower axes thereof and the absorption or transmission axes of the second polarizer 2j and polarizing element 5 satisfy the axial relationship shown in FIG. 6. In this preferred embodiment, the first and second λ/4 retarders were made of polycarbonate with a Δn of about 0.00138 and a thickness of about 100 μm.

The optical properties of the liquid crystal display device of this preferred embodiment are also shown in Table 1.

Based on the results shown in Table 1, the present inventors confirmed that the display device of this second preferred embodiment also ensured good display quality while minimizing the decrease in brightness.

In the first or second preferred embodiment of the present invention described above, one of the optical elements, including the polarizing element, light diffusing layer and λ/4 retarders, may be integrated with another component to reduce the number of components required. For example, at least one of the first and second polarizers may be integrated with associated one of the transparent substrates of the liquid crystal cell.

It should be noted that the “polarizer” herein has only to be an optical element having the function of selecting polarization and is not necessarily limited to a polarizing plate commercially available. Furthermore, the “polarizer” may also have any other optical function, not just the polarization selection.

As described above, a transmission type display device according to the present invention can also reduce the unwanted retroreflection just like the conventional display device including a light absorbing layer in its light diffusing layer, and yet can minimize the decrease in brightness of the outgoing light.

The above-mentioned transmission type display device may be used in electronic apparatus like word processors, notebook computers, various types of video or game appliances, TV receivers and other electronic appliances.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A transmission type display device comprising:
a backlight source;
a display element, which is disposed in front of the backlight source and includes at least one polarizer;
a light diffusing element, which is disposed in front of the display element; and
a polarizing element, which is disposed in front of the light diffusing element,
wherein the polarizer included in the display element faces the light diffusing element, and
wherein an absorption axis of the polarizing element is substantially aligned with that of the polarizer.

2. The device of claim 1, wherein the display element comprises:
a transmission type liquid crystal display panel, which includes a liquid crystal layer and a pair of transparent substrates that sandwiches the liquid crystal layer therebetween;
a first polarizer, which is disposed as an additional polarizer on the transmission type liquid crystal display panel so as to face the backlight source; and
a second polarizer, which is disposed as the at least one polarizer on the transmission type liquid crystal display panel so as to face the light diffusing element,
wherein an absorption axis of the second polarizer is substantially aligned with that of the polarizing element.

3. The device of claim 2, further comprising:
a first λ/4 retarder disposed between the second polarizer and the light diffusing element; and
a second λ/4 retarder disposed between the light diffusing element and the polarizing element,
wherein a slower axis of the first λ/4 retarder forms an angle of about 45 degrees with an absorption axis or transmission axis of the second polarizer, and
wherein a slower axis of the second λ/4 retarder forms an angle of about 90 degrees with that of the first λ/4 retarder.

4. The device of claim 2, wherein at least one of the first and second polarizers is integrated with an associated one of the transparent substrates.

5. The device of claim 1, wherein the display element comprises:
a guest host type liquid crystal display panel; and
the at least one polarizer disposed in front of a light outgoing plane of the guest host type liquid crystal display panel.

6. The device of claim 5, wherein the polarizer is integrated with a transparent substrate of the guest host type liquid crystal display panel, the transparent substrate being located closer to the light outgoing plane.

7. A transmission type display device comprising:
a backlight source;
a display element, which is disposed in front of the backlight source and outputs polarized light;
a light diffusing element, which is disposed in front of the display element; and
a polarizing element, which is disposed in front of the light diffusing element,
wherein an absorption axis of the polarizing element is defined so that substantially all of the polarized light that has been output from the display element is transmitted through the polarizing element.

8. A transmission type display device comprising:
a backlight source for emitting polarized light;
a guest host type liquid crystal display element, which is disposed in front of the backlight source; and
a polarizing element, which is disposed in front of the guest host type liquid crystal display element,
wherein an absorption axis of the polarizing element is defined so that substantially all of the polarized light is transmitted through the polarizing element.

9. An electronic apparatus comprising a transmission type display device, wherein the display device includes:
a backlight source;
a display element, which is disposed in front of the backlight source and includes at least one polarizer;
a light diffusing element, which is disposed in front of the display element; and
a polarizing element, which is disposed in front of the light diffusing element,
wherein the polarizer included in the display element faces the light diffusing element, and
wherein an absorption axis of the polarizing element is substantially aligned with that of the polarizer.

10. An electronic apparatus comprising a transmission type display device, wherein the display device includes:
a backlight source;
a display element, which is disposed in front of the backlight source and outputs polarized light;
a light diffusing element, which is disposed in front of the display element; and
a polarizing element, which is disposed in front of the light diffusing element,
wherein an absorption axis of the polarizing element is defined so that substantially all of the polarized light that has been output from the display element is transmitted through the polarizing element.

11. An electronic apparatus comprising a transmission type display device, wherein the display device includes:
a backlight source for emitting polarized light;
a guest host type liquid crystal display element, which is disposed in front of the backlight source; and
a polarizing element, which is disposed in front of the guest host type liquid crystal display element,
wherein an absorption axis of the polarizing element is defined so that substantially all of the polarized light is transmitted through the polarizing element.
